(19) United States
(12) Patent Application Publication
(10) Pub. No.: US 2015/0082063 A1
(43) Pub. Date: Mar. 19, 2015

(54) BASEBOARD MANAGEMENT CONTROLLER STATE TRANSITIONS

(71) Applicant: Lenovo (Singapore) Pte. Ltd., Singapore (SG)

(72) Inventors: Nathan J. Peterson, Durham, NC (US); Amy Leigh Rose, Chapel Hill, NC (US); Jennifer J. Lee-Baron, Morrisville, NC (US); John Scott Crowe, Durham, NC (US); James C. Loebach, Raleigh, NC (US); Nagananda Chumbalkar, Cary, NC (US)

(73) Assignee: Lenovo (Singapore) Pte. Ltd., Singapore (SG)

(21) Appl. No.: 14/030,527

(22) Filed: Sep. 18, 2013

(51) Int. Cl. G06F 1/32; G06F 13/40

(52) U.S. Cl. CPC G06F 1/3234; G06F 13/40
USPC 713/323; 713/320

(57) ABSTRACT

An apparatus can include a circuit board; a processor mounted to the circuit board; memory accessible by the processor; a storage subsystem accessible by the processor; a network interface that includes network states; a controller mounted to the circuit board and operatively coupled to the network interface where the controller includes power states; and transition circuitry that transitions the controller from one of the power states to another one of the power states responsive to a transition of the network interface from one of the network states to another one of the network states. Various other apparatuses, systems, methods, etc., are also disclosed.

### TECHNICAL FIELD

Subject matter disclosed herein generally relates to technologies and techniques for controllers such as, for example, baseboard management controllers.

### BACKGROUND

An information handling system such as, for example, a server, may include host components that can establish a host operating system environment for executing applications, handling information, etc. As an example, a server may include a controller such as, for example, a baseboard management controller. Various technologies and techniques described herein can provide for transitioning controller states, for example, including transitioning controller power states.

### SUMMARY

An apparatus can include a circuit board; a processor mounted to the circuit board; memory accessible by the processor; a storage subsystem accessible by the processor; a network interface that includes network states; a controller mounted to the circuit board and operatively coupled to the network interface where the controller includes power states; and transition circuitry that transitions the controller from one of the power states to another one of the power states responsive to a transition of the network interface from one of the network states to another one of the network states. Various other apparatuses, systems, methods, etc., are also disclosed.

### BRIEF DESCRIPTION OF THE DRAWINGS

Features and advantages of the described implementations can be more readily understood by reference to the following description taken in conjunction with the accompanying drawings.

FIG. 1 is a diagram of an example of a server and an example of a board with various components;

FIG. 2 is a diagram of an example of a system that includes a controller and a processor;

FIG. 3 is a diagram of an example of a system and an example of logic;

FIG. 4 is a diagram of an example of a system and an example of circuitry;

FIG. 5 is a diagram of an example of a system and an example of a method;

FIG. 6 is a diagram of an example of a server, examples of network interfaces, an example of a system and an example of a method;

FIG. 7 is a diagram of an example of a method, an example of circuitry and an example of logic; and

FIG. 8 is a diagram of an example of various components of a machine (e.g., a device, a system, etc.).

### DETAILED DESCRIPTION

The following description includes the best mode presently contemplated for practicing the described implementations. This description is not to be taken in a limiting sense, but rather is made merely for the purpose of describing general principles of the implementations. The scope of the described implementations should be ascertained with reference to the issued claims.

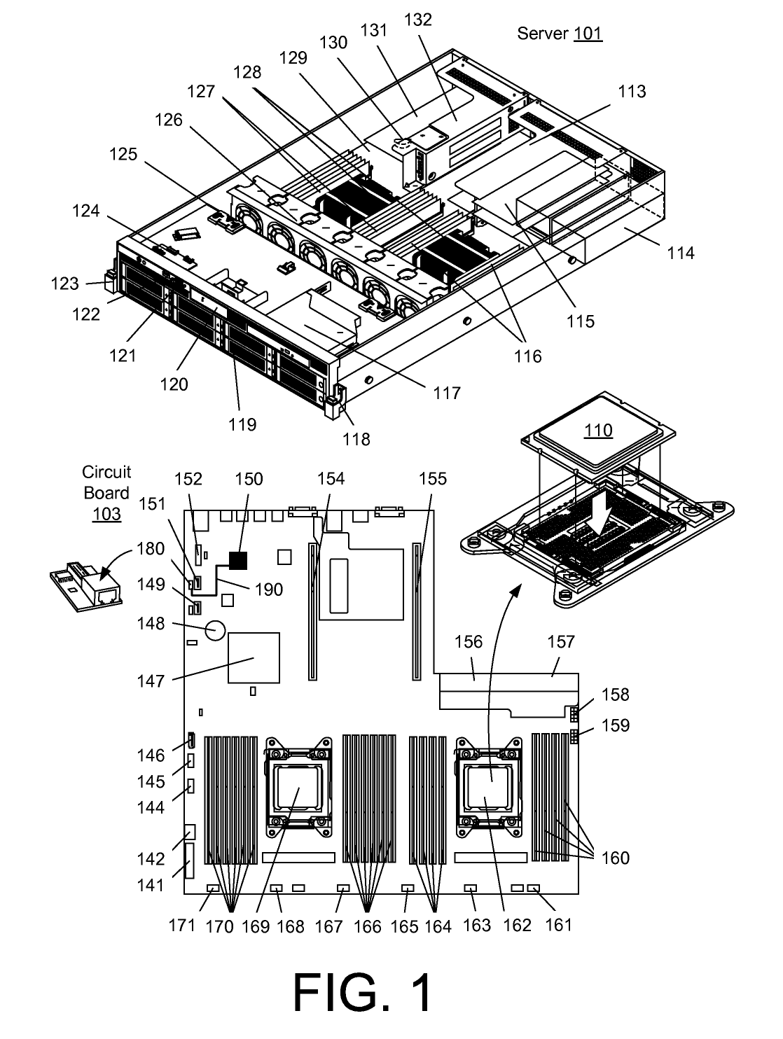

FIG. 1 shows an example of a server 101 and an example of a circuit board 103 that may be part of the server 101. As shown in the example of FIG. 1, the server 101 can include a riser card assembly 113, one or more hot-swap power supplies 114, one or more PCI-express card 115, a first set of DIMMs 116 (e.g., processor-accessible memory slots, memory modules, etc.), an optical drive 117, a right-side rack handle 118, a hard disk drive area 119, a diagnostic module 120, a VGA DB-connector 121, a USB port 122, a left-side rack handle 123, a front panel board 124, a backplane for hard disk drives 125, system fans 126, a second set of DIMMs 127, heat sinks (e.g., with processors beneath) 128, a circuit board (e.g., or system board) 129, a circuit board battery 130, one or more other PCI-express cards 131 and another riser card assembly 132.

As to the circuit board 103, it may be suitable for use as the circuit board 129 of the server 101. As shown in the example of FIG. 1, the circuit board 103 can include a front panel connector 141, an internal USB connector 142, a diagnostic module connector 144, a front VGA connector 145, a SATA connector 146, a platform controller hub or host (PCH) 147, a circuit board battery 148, an internal USB Type A port 149, a controller 150, another internal USB Type A port 151, a TPM (Trusted Platform Module) connector 152 (e.g., to operatively couple to a TPM, another type of security module, etc.), a riser card assembly slot 154, another riser card assembly slot 155, a power supply connector 156, another power supply connector 157, a backplane power connector 158, another backplane power connector 159, memory slots 160, 164, 166 and 170, system fan connectors 161, 163, 165, 167, 168 and 171 and processor sockets 162 and 169 where each of the processor sockets 162 and 169 may seat a respective processor (see, e.g., a perspective view of the processor socket 162 and a processor 110).

As an example, a processor may be in the form of a chip (e.g., a processor chip) that includes one or more processing cores. As an example, a processor socket may include protruding pins to make contact with pads of a processor chip, which may be, for example, a multicore processor chip (e.g., a multicore processor). As an example, a processor socket may include features of a “Socket H2” (Intel Corp, Santa Clara, Calif.), a “Socket H3” (Intel Corp, Santa Clara, Calif.), “Socket R3” (Intel Corp, Santa Clara, Calif.) or other socket. As an example, a processor chip (e.g., processor) may optionally include more than about 10 cores (e.g., “Haswell-EP”, “Haswell-EX”, etc. of Intel Corp.). As an example, a processor chip may include one or more of cache, an embedded GPU, etc.

As an example, the circuit board 103 may include a controller connector module 180 that may be operatively coupled to the controller 150, for example, via circuitry 190 (e.g., conductors, etc.).

As an example, communications (e.g., signal sending, signal receipt, etc.) may occur according to a layer model. For example, such a model may include a Physical Layer (PHY) that can couple to a Media Access Control (MAC) and vice versa. For example, a PHY may be associated with an optical or wire cable and a MAC may be associated with a device (e.g., a link layer device, etc.) that may receive information from the PHY (e.g., received via a cable) and transmit information to the PHY (e.g., for transmission via a cable).

As an example, the controller connector module 180 of the circuit board 103 may provide for remote “keyboard, video and mouse” (KVM) access and control through a LAN and/or the Internet, for example, in conjunction with the controller 150, which may be a baseboard management controller (BMC). As an example, the controller connector module 180 may provide for location-independent remote access to one or more circuits of the circuit board 103, for example, to respond to incidents, to undertake maintenance, etc.

As an example, the controller connector module 180 may include features such as an embedded web server, a soft keyboard via KVM, remote KVM, virtual media redirection, a dedicated network interface card (NIC), security (e.g., SSL, SSH, KVM encryption, authentication using LDAP or RADIUS), email alert, etc.

As an example, the controller connector module 180 may be a network adapter (e.g., a network interface). For example, in the example of FIG. 1, the controller connector module 180 is shown as optionally including a receptacle that is configured to receive a plug (e.g., of a cable, etc.). As an example, a utility program may be provided for setting an IP address (e.g., a static IP address or dynamic IP address) for the controller 150. Such a program may include a BMC LAN configuration option and may include options for an identifier and a password. As an example, a controller may be accessed via an IP address (e.g., http://10.223.131.36), for example, using a web-browser program executing on a machine.

As an example, the controller connector module 180 may include a receptacle with electrical connectors that can operatively couple electrical connectors of a plug with the circuitry 190 to operatively couple the electrical connectors of the plug with the controller 150. In such an example, the controller connector module 180 may include PHY circuitry. As an example, the controller 150 may include one or more MAC modules (e.g., one or more 10/100/1000M bps MAC modules, etc.), for example, that can be operatively coupled to PHY circuitry.

As an example, the controller connector module 180 may include PHY circuitry (e.g., it may be a PHY device or a “PHYceiver”). For example, the controller connector module 180 may include one or more PHY chips, for example, one for each MAC module of a controller where such a controller includes multiple MAC modules. An Ethernet PHY chip may implement hardware send and receive functions for Ethernet frames (e.g., interface to line modulation at one end and binary packet signaling at another end). As an example, a system may include so-called USB PHY circuitry (e.g., a PHY chip integrated with USB controller circuitry to bridge digital and modulated parts of an interface).

As an example, the controller connector module 180 may be integrated with the controller 150, for example, as an integrated management module. As an example, an integrated management module may include at least some features of the Integrated Management Module (IMM) as marketed by Lenovo (US) Inc., Morrisville, N.C. As an example, an integrated management module or the controller 150 and the controller connector module 180 may include circuitry for one or more of: (i) choice of dedicated or shared Ethernet connection; (ii) an IP address for an Intelligent Platform Management Interface (IPMI) and/or a service processor interface; (iii) an embedded Dynamic System Analysis (DSA); (iv) an ability to locally and/or remotely update other entities (e.g., optionally without requiring a server); (v) a restart to initiate an update process; (vi) enable remote configuration with an Advanced Settings Utility (ASU); (vii) capability for applications and tools to access the IMM in-band and/or out-of-band; and (viii) one or more enhanced remote-presence capabilities.

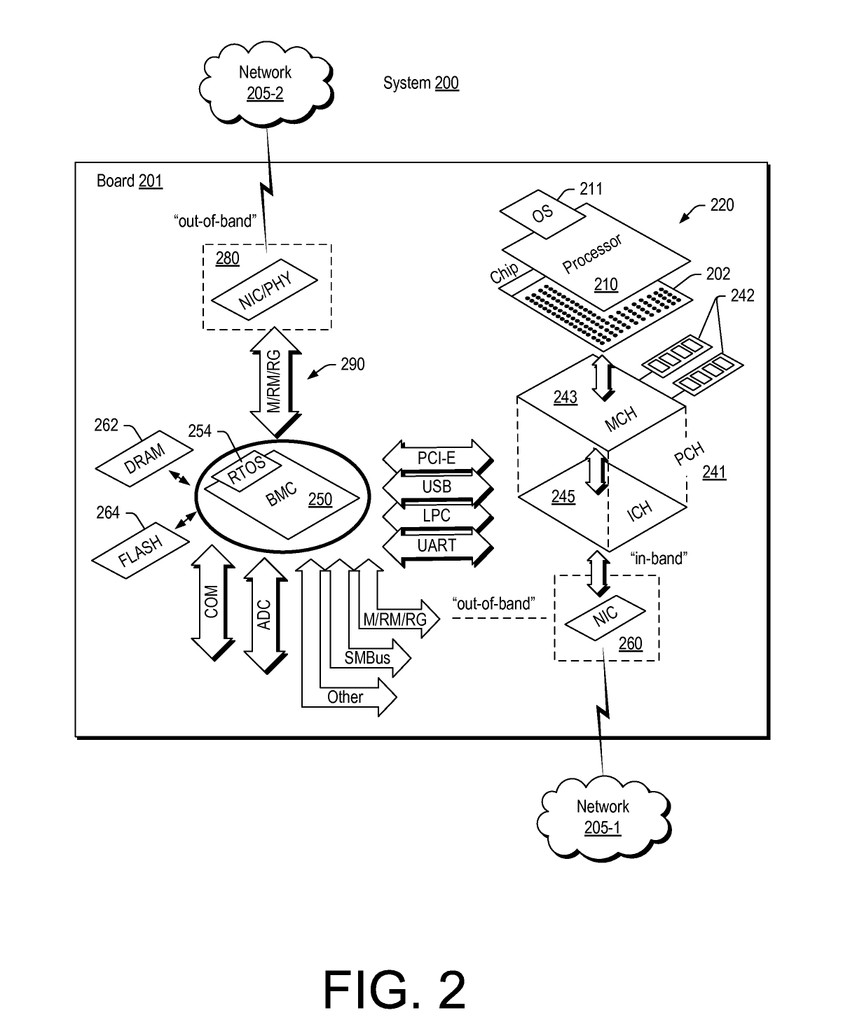

FIG. 2 shows an example of a system 200 that includes a board 201 for a processor chip 202, for a platform controller hub or host (PCH) 241 and for a controller 250, which may be referred to as a baseboard management controller (BMC) (see, e.g., the controller 150 of FIG. 1).

As shown in the example of FIG. 2, the processor chip 202 includes a processor 210 that may execute an operating system 211, for example, to establish an operating system environment. In the example of FIG. 2, the processor chip 202 is operatively coupled to a memory controller host (MCH) 243 and an input/output controller host (ICH) 243, which may be, for example, components of the PCH 241. In the example of FIG. 2, the MCH 243 is operatively coupled to the memory 242 (see, e.g., the DIMMs 160, 164, 166 and 170 of the circuit board 103 of FIG. 1) and the ICH 245 is operatively coupled to a network interface controller (NIC) 260. As an example, the processor 210 may be operatively coupled to the memory 242 (e.g., system memory) via the processor chip 202 and, for example, via a socket that may be operatively coupled to DIMMs. The components illustrated as a vertical stack (right hand side of FIG. 2) may be considered “host” components (e.g., a host 220) that support the establishment of an operating system environment using the processor 210, for example, to execute applications.

In the example of FIG. 2, the controller 250 includes a RTOS 254 and various interfaces. As an example, the controller 250 may include dedicated network support, for example, via circuitry 280 (e.g., a NIC, PHY circuitry, etc.). For example, the circuitry 280 may be dedicated to the controller 250 (e.g., a dedicated NIC, dedicated PHY circuitry, etc.). As an example, the NIC 260 and/or the circuitry 280 may provide for out-of-band (OOB) communication with the controller 250 (e.g., via the network 205-1 and/or the network 205-2; see, e.g., the module 180 of FIG. 1). As an example, the controller 250 may include one or more MAC modules (e.g., that may be operatively coupled to one or more PHY devices). As an example, a controller may include an IP address, for example, that may differ from an IP address associated with host components on a board (e.g., the controller 250 may include an associated IP address that differs from an associated IP address of the host 220).

In the example of FIG. 2, the controller 250 may include interfaces to access components such as, for example, DRAM 262, flash (e.g., optionally SPI flash) 264, etc. The controller 250 may include interfaces for communication with one or more of the MCH 243 and the ICH 245, for example, via a PCI-express interface (PCI-E), a USB interface, a low pin count interface (LPC), etc. The controller 250 may include an interface configured in compliance with a SMB specification (e.g., a “SMBus” specification). Such an interface may be configured for communications, control, data acquisition, etc. with one or more components on a motherboard (e.g., power related components, temperature sensors, fan sensors, voltage sensors, mechanical switches, clock chips, etc.).

As an example, the controller 250 may be optionally compliant with an Intelligent Platform Management Interface (IPMI) standard. The IPMI may be described, for example, as a message-based, hardware-level interface specification. In a system, an IPMI subsystem may operate independently of an OS (e.g., host OS), for example, via out-of-band communication. The IPMI may be suitable for use by a system administrator, for example, to perform out-of-band management of a system (e.g., monitoring operation, etc.).

In the example of FIG. 2, an OS environment may be established using, for example, a WINDOW® OS (e.g., a full OS), an APPLE® OS, an ANDROID® OS or other OS capable of establishing an environment for execution of applications (e.g., word processing, drawing, email, etc.). As an example, the controller 250 may establish an RTOS such as, for example, the NUCLEUS® RTOS, a RISC OS, embedded OS, etc.

As an example, the controller 250 may be an ARC-based controller that can function as a baseboard management controller (BMC) (e.g., an ARC4 processor with an I-cache, a D-cache, SRAM, ROM, etc.). As an example, a BMC may include an expansion bus, for example, for an external flash PROM, external SRAM, and external SDRAM. A BMC may be part of a management microcontroller system (MMS), which, for example, operates using firmware stored in ROM (e.g., optionally configurable via EEPROM, strapping, etc.).

As an example, the controller 250 may include an ARM architecture, for example, consider a controller with an ARM926 32-bit RISC processor. As an example, a controller with an ARM architecture (e.g., an ARM-based controller) may optionally include a Jazelle® technology enhanced 32-bit RISC processor with flexible size instruction and data caches, tightly coupled memory (TCM) interfaces and a memory management unit (MMU). In such an example, separate instruction and data AMBA® AHB™ interfaces suitable for Multi-layer AHB based systems may be provided. The Jazelle® DBX (Direct Bytecode eXecution) technology, for example, may provide for execution of bytecode directly in the ARM architecture as a third execution state (and instruction set) alongside an existing mode.

As an example, the controller 250 may be configured to perform tasks associated with one or more sensors (e.g., scanning, monitoring, etc.), for example, as part of an Intelligent Platform Management Interface (IPMI) management scheme. As an example, a sensor may be or include a hardware sensor (e.g., for temperature, etc.) and/or a software sensor (e.g., for states, events, etc.). As an example, a controller (e.g., a BMC) may provide for out-of-band management of a computing device (e.g., an information handling system), for example, via a network interface.

As an example, a controller may be configured to implement one or more server-related services. For example, a chipset may include a server management mode (SMM) interface managed by a BMC. In such an example, the BMC may prioritize transfers occurring through the SMM interface. In such an example, the BMC may act as a bridge between server management software (SMS) and IPMI management bus (IPMB) interfaces. Such interface registers (e.g., two 1-byte-wide registers) may provide a mechanism for communications between the BMC and one or more host components.

As an example, a controller (e.g., the controller 250) may store configuration information in protected memory (see, e.g., the DRAM 262, the flash 264, etc.). As an example, stored information may include the name(s) of appropriate “whitelist” management servers (e.g., for a company, etc.). As an example, the controller 250 may be operable in part by using instructions stored in memory such as the DRAM 262 and/or the flash 264. As an example, such instructions may provide for implementation of one or more methods that include monitoring, assessing, etc. operation of one or more of host components by the controller 250.

As an example, the NIC 260 of the system 200 of FIG. 2 may be a LAN subsystem PCI bus network adapter configured to monitor network traffic, for example, at a so-called Media Independent Interface (MII), a Reduced Media Independent Interface (RMII), a Reduced Gigabit Media Independent Interface (RGMII), etc. As an example, the NIC 260 may include various features, for example, a network adapter may include a Gigabit Ethernet controller, a RJ-45 LAN connector, a CSMA/CD protocol engine, a LAN connect interface between a PCH and a LAN controller, PCI bus power management, ACPI technology support, LAN wake capabilities, ACPI technology support, LAN subsystem software, etc.

As an example, a network adapter (e.g., a NIC, etc.) may be chip-based with compact, low power components with at least PHY circuitry and optionally with MAC circuitry. Such a network adapter may use a PCI-express (PCI-E) architecture, for example for implementation as a LAN on a motherboard (LOM) configuration or, for example, embedded as part of a switch add-on card, a network appliance, etc. (e.g., consider a NIC-based controller for a NIC of a motherboard).

As an example, a network (e.g., the network 205-1, the network 205-2, etc.), the controller 250 and the circuitry 280 of the system 200 of FIG. 2 may be operatively coupled via one or more interfaces and, for example, conductors 290 (e.g., a bus, etc.). As an example, such one or more interfaces may include features specified by the MII, the RMII, the RGMII, etc.

As an example, the RGMII can achieve a reduction in pins (e.g., from 24 pins to 12 pins) by clocking data on both rising and falling clock edges (e.g., in 1000 Mbit/s operation) and by eliminating non-essential signals (e.g., carrier-sense and collision-indication). As an example, the RGMII may specify: RX_CTL, RXC, RXD[3:0], TX_CTL, TXC, TXD[3:0] (e.g., which may be implemented using 12 pins). As an example, a transmit clock signal may be provided by MAC on a TXC line (e.g., rather than being provided by PHY circuitry for 10/100 Mbit/s operation and by the MAC at 1000 Mbit/s).

As an example, an incoming packet (e.g., incoming via the circuitry 280, etc.) may be processed using a MAC engine, which may be part of a controller such as the controller 250. In such an example, where an address check is successful, the MAC engine may save the received packet in a FIFO register and then transfer the packet using a DMA feature. As an example, a MAC engine may issue notifications (e.g., interrupts, etc.) as to packet receipt, etc. As an example, a controller may include one or more MAC modules (e.g., for instantiating one or more MAC engines). In such an example, each MAC module may have an associated MAC base address (e.g., a base address for each MAC module).

As an example, the board 201 may include components such as those marketed by Intel Corporation (Santa Clara, Calif.). As an example, one or more components of the host 220 may support the Intel® Active Management Technology (AMT), as a hardware-based technology for remotely managing and securing computing systems in out-of-band operational modes. In the example of FIG. 2, the Intel® AMT may be implemented using components of the host 220. For example, Intel® AMT may be realized using an ARC4 chip in the MCH 243 of the host 220 to instantiate the so-called Intel® Management Engine (ME) via code that resides in the same flash memory as that of host BIOS (e.g., accessible via the ICH 245). The Intel® ME shares a common LAN MAC, hostname, and IP address with the host (e.g., the host OS). The Intel® ME relies on an out-of-band filter to filter information received via a LAN interface (see, e.g., the NIC 260 of FIG. 2).

As an example, a controller may be separate from a host, for example, consider an Aspeed® AST1 XXX or 2XXX series controller marketed by Aspeed Technology Inc. (Hsinchu, TW). As an example, the controller 250 of FIG. 2 may include at least some features of an Aspeed® controller.

As an example, the system 200 may be part of a server. For example, consider a RD630 ThinkServer® system marketed by Lenovo (US) Inc. of Morrisville, N.C. Such a system may include, for example, multiple sockets for processors. As an example, a processor may be an Intel® processor (e.g., XEON® E5-2600 series, XEON® E3-1200v3 series (e.g., Haswell architecture), etc.). As an example, a server may include an Intel® chipset, for example, such as one or more of the Intel® C6XX series chipset. As an example, a server may include RAID hardware (e.g., RAID adapters, etc.). As an example, a server may include hypervisor instructions for establishing a hypervisor environment, for example, to support virtual OS environments, etc. As an example, a server may include a controller such as, for example, a controller that includes at least some features of an Aspeed® controller.

As an example, the controller 150 of the circuit board 103 of FIG. 1 may be an Aspeed® controller or include at least some features of such a controller. As an example, the controller connector module 180 of the circuit board of FIG. 1 may be configured to operatively couple to an Aspeed® controller or a controller that includes at least some features of such a controller. As an example, the circuitry 190 of FIG. 1 may operatively couple a network interface (e.g., network adapter, PHY circuitry, etc.) to the controller 150, for example, where the controller connector module 180 includes the network interface (e.g., network adapter, PHY circuitry, etc.).

As an example, the server 101 of FIG. 1 (e.g., or the circuit board 103 of FIG. 1) may include a socket for a network interface controller (NIC) that may include, for example, one or more features of an Intel® Ethernet controller, for example, an Intel® 82574 GbE controller, an Intel® 82583V GbE controller, etc.

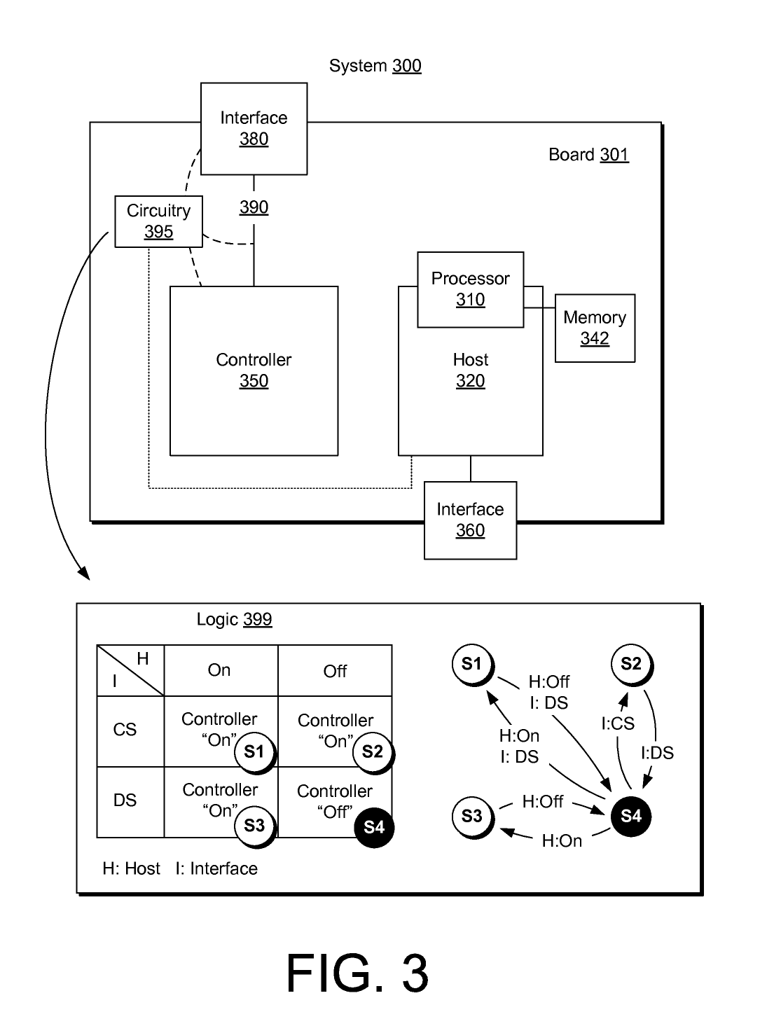

FIG. 3 shows an example of a system 300 that includes a board 301, a processor 310 of a host 320, memory 342 accessible by the processor 310, a controller 350, an interface 360 at least operatively coupled to the host 320, an interface 380 operatively coupled to the controller 350, for example, via conductors 390, and circuitry 395 that can control power state of the controller 350 responsive to one or more states of the interface 380.

As an example, an apparatus can include a circuit board; a processor mounted to the circuit board; memory accessible by the processor; a storage subsystem accessible by the processor; a network interface that includes network states; a controller mounted to the circuit board and operatively coupled to the network interface where the controller includes power states; and transition circuitry that transitions the controller from one of the power states to another one of the power states responsive to a transition of the network interface from one of the network states to another one of the network states.

As an example, the system 300 may be an apparatus that includes the board 301 as a circuit board; the processor 310 as a processor mounted to the board 301; the memory 342 as memory accessible by the processor 310; a storage subsystem accessible by the processor 310 (e.g., a RAID or other storage subsystem); the interface 380 as a network interface that includes network states; the controller 350 as a controller mounted to the board 301 and operatively coupled to the interface 360 where the controller 350 includes power states; and the circuitry 395 as transition circuitry that transitions the controller 350 from one of the power states to another one of the power states responsive to a transition of the interface 380 from one of the network states to another one of the network states.

As an example, a network state may be a connected state or a disconnected state. As an example, network states may include a connected state and a disconnected state. As an example, a connected state may be defined as a state where a receptacle receives a plug (e.g., a plugged-in state) and a disconnected state may be defined as a state where a receptacle does not receive a plug (e.g., an unplugged state). As an example, a connected state may be defined as a state where an interface receives a signal (e.g., an electrical signal, an optical signal, etc.) and a disconnected state may be defined as a state where an interface does not receive a signal (e.g., an electrical signal, an optical signal, etc.). As an example, an electromagnetic signal may be an electrical signal or an optical signal.

As an example, circuitry may include a switch that can transition from one state to another state responsive to a receptacle, an interface, etc. transitioning from a connected state to a disconnected state or from a disconnected state to a connected state. As an example, circuitry may include a multi-directional switch that can perform different types of transitions, for example, one type of transition responsive to a receptacle, an interface, etc. transitioning from a connected state to a disconnected state and another type of transition responsive to a receptacle, an interface, etc. transitioning from a disconnected state to a connected state.

As an example, a power state of a controller may be an on state. As an example, a power state of a controller may be an off state. As an example, power states of a controller may include an on state and an off state.

As an example, where a controller is in an on state and where a network interface transitions from a connected state to a disconnected state, transition circuitry may transition the controller from the on state to an off state. As an example, transition circuitry may operate based at least in part on a power state of a host. For example, where a host is in an off state, the transition circuitry may allow for transition of a controller from an on state to an off state while where a host is not in an off state, the transition circuitry may disallow (e.g., prohibit) for transition of a controller from an on state to an off state. As an example, transition circuitry may be configured as a state machine that operates according to state of an interface and to state of a host.

As an example, transition circuitry may include one or more inputs for state of an interface (see, e.g., dashed line to interface 380 or dashed line to conductors 390) and optionally state of a host (e.g., directly from a host per dotted line to the host 320, indirectly from a controller per dashed line to the controller 350, etc.). As an example, transition circuitry may include one or more inputs for state of an interface (see, e.g., dashed line to interface 380 or dashed line to conductors 390), state of a controller (see, e.g., dashed line to controller 350) and optionally state of a host (e.g., directly from a host per dotted line to the host 320, indirectly from a controller per dashed line to the controller 350, etc.).

FIG. 3 shows logic 399 that may be implemented by the transition circuitry 395. For example, per a logic table where a host is in an on state and an interface is in a connected state (CS), a controller remains on; where a host is in an on state and an interface is in a disconnected state (DS), a controller remains on; where a host is in an off state and an interface is in a connected state (CS), a controller remains on; and where a host is in an off state and an interface is in a disconnected state (CS), a controller is in an off state. As an example, given the logic table, a state diagram may be constructed, for example, as shown in FIG. 3 where states S1, S2 and S3 are on states for a controller and S4 is an off state for a controller. As indicated, one or more events may cause transitions from one state to another (e.g., to transition a controller from an off state to an on state, to transition a controller from an on state to an off state).

As an example, the circuitry 395 may be part of the interface 380, may include one or more of the conductors 390, be part of the controller 350, or be a separate component that may be operatively coupled to one or more other components. As an example, the circuitry 395 may be distributed, for example, as part of an interface and as part of a controller.

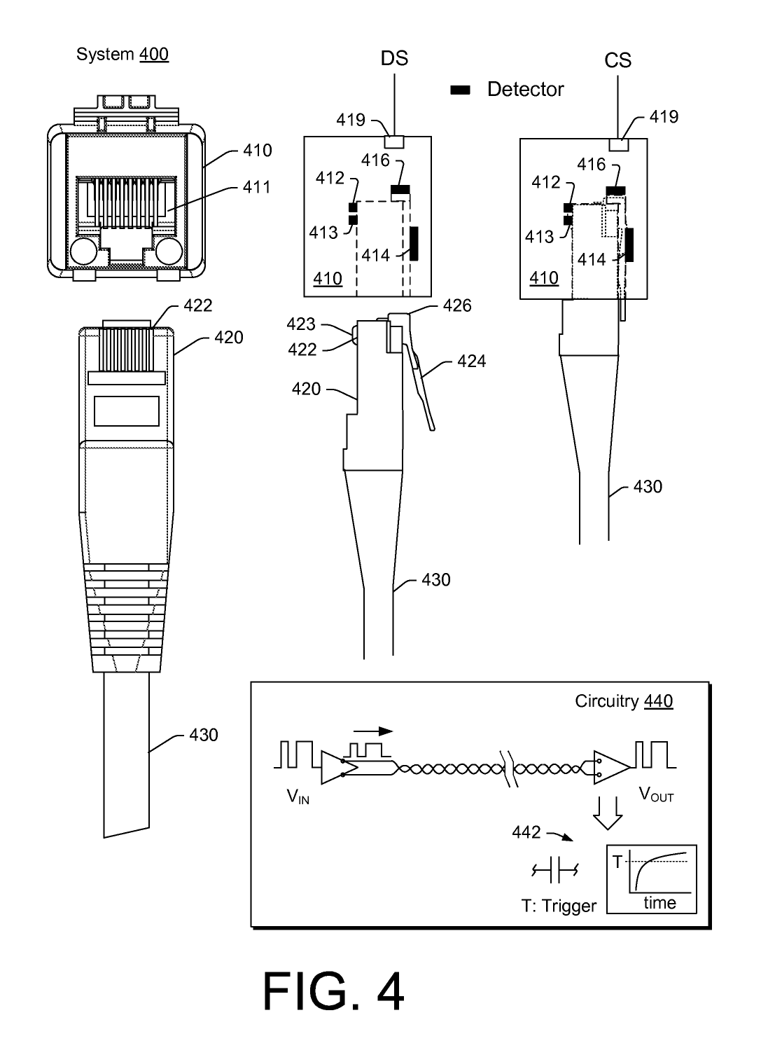

FIG. 4 shows an example of a system 400 that includes a receptacle housing 410 that defines a receptacle 411 (e.g., a socket) and a plug 420 with a cable 430. As shown, the receptacle housing 410 may include one or more detectors 412, 413, 414 and 416 that may detect presence or absence of the plug 420, for example, to indicate a connected state (CS) and/or a disconnected state (DS). As an example, the receptacle housing 410 may include an interface 419 that can provide a signal such as, for example, a disconnect signal for a disconnected state (DS), a connect signal for a connected state (CS) or, for example, a disconnect signal for a disconnected state (DS) and a connect signal for a connected state (CS). As an example, circuitry may operate according to such a signal to transition a controller to a particular power state.

As an example, as to the detector 412, the plug 420 may include conductors 422 (e.g., pins) where one or more of the conductors act to bridge a gap of the detector 412 for detecting presence of the plug 420 in the receptacle 411. As an example, the plug 420 may include a ridge 423 that may be detected by the detector 413 upon insertion of the plug 420 into the receptacle 411. As an example, the detector 414 may detect presence of a prong 424 of the plug 420 where the plug 420 is received by the receptacle 411. As an example, the detector 416 may detect a nose 426 of the plug 420 where the plug 420 is received by the receptacle 411. As an example, a detector may be a pressure sensor (e.g., a pressure switch), for example, to detect a ridge, a nose, a prong or another portion of a plug. As an example, a detector may detect conduction, resistance, capacitance associated with a plug.

As an example, a detector may include emission and detection circuitry, for example, with an emitter and a detector. In such an example, the emitter may be pulsed to converse power (e.g., a short pulse with a frequency of the order of seconds). In such an example, the detector may detect reflected and/or transmitted electromagnetic energy (e.g., IR, VIS, UV, etc.). As an example, once a plug is received by a receptacle, a detector may optionally be powered off and subsequently reactivated upon removal of the plug from the receptacle, for example, to be in an inspection state (e.g., via periodic emission of energy).

FIG. 4 also shows an example of circuitry 440 that includes an energy storage circuit 442 (e.g., a capacitor, capacitors, etc.). As an example, the energy storage circuit 442 may store signal energy for signals carried on a cable. In such a manner, the circuitry 440 may detect whether a cable is plugged-in to a receptacle and active, whether a cable is plugged-in to a receptacle and not active or whether a cable is not plugged-in to a receptacle. As an example, the circuitry 440 may be a state machine.

As an example, the circuitry 440 may be passive, for example, where signal energy causes the circuitry 440 to trigger a state transition. For example, where a signal is present for a plugged-in cable, energy in the signal may be stored to reach a level sufficient to trigger a state transition (e.g., stored in a storage circuit) or, for example, sufficient in itself to trigger a state transition. Such circuitry may be signal dependent. Such circuitry may optionally be implemented in conjunction with one or more other detection circuits, for example, consider one or more of the detectors 412, 413, 414 and 416.

As an example, a system may be configurable to implement one or more detection circuits. For example, where a cable remains plugged-in to a receptacle and may be electrically disconnected upstream of the receptacle (e.g., via a switching unit), a user may configure the system to implement circuitry such as the circuitry 440. As another example, where a cable is to be plugged-in and plugged-out, a user may configure the system to implement circuitry such as that of one of the detectors 412, 413, 414 and 416, optionally in addition to implementation of circuitry such as the circuitry 440.

As an example, where both a physical connection detection approach and a signal detection approach are implemented, logic may include various states and state transitions based in part on both approaches. For example, where a cable is plugged-in to a receptacle and there is no signal present for a period of time, a transition may occur, which, in turn, may transition a controller from one state to another state (e.g., from an on state to an off state). In such an example, where a signal becomes present, a transition may occur, which, in turn, may transition a controller from one state to another state (e.g., from an off state to an on state). As an example, such logic may depend in part on state of a host (e.g., a host processor). As an example, states and state transitions may be programmable, for example, using one or more inputs to control one or more outputs (e.g., transitioning the power state of a controller).

As an example, equipment may include Category 5 equipment (see, e.g., ANSI/TIA/EIA-568-A and TSB-95). As an example, a cable type, a connector type, a cabling topology may be include one of those defined by TIA/EIA-568-B. As an example, a receptacle housing may be an 8P8C modular connector (e.g., sometimes referred to as RJ45), which may be suitable for connecting Category 5 cable (e.g., Cat5, Cat5e, etc.). As an example, a cable may be terminated according to a T568A scheme or a T568B scheme. While Category 5 and 8P8C are mentioned, as examples, equipment may be provided according to one or more other categories, standards, etc.

As an example, a server may include a controller (e.g., a BMC, a “service processor”, etc.) that may run background processes for management of the server. In such an example, the controller may include a RTOS, for example, to handle management tasks (e.g., remote management tasks, local management tasks for the server and its resources, etc.). As an example, where host components of a server (see, e.g., the host 220 of FIG. 2) are powered down (e.g., in an off state), a controller and associated circuitry may be in an on state that consumes about 5 watts or more. As an example, where a server facility includes 1,000 servers, such power consumption would be about 5,000 watts (e.g., 5 kW) and about 120 kWh per day. Given a power cost of about $0.15 per kWh, the cost for power consumption alone would be about $18 per day or about $540 per month (e.g., about $6,500 per year). As an example, additional costs may be incurred, for example, via associated cooling.

As explained with respect to various examples of FIG. 3 and FIG. 4, rather than unplugging a server's power cord, circuitry may be provided that powers down a controller (e.g., and associated circuitry) where host components of the server are not being used. While various examples mention a controller “off” state and a controller “on” state, a controller may be transitioned to and/or from a variety of power states. For example, a controller may include a low power state that consumes less power than in the aforementioned example (e.g., a low power state that consumes less than about 5 watts).

As an example, a method may include transitioning a controller (e.g., a BMC) into a low power state by dynamically detecting if the controller is necessary at a particular time. As an example, where a schedule is provided, circuitry may be implemented that may call for transitions or types of states based at least in part on the schedule.

As an example, a signal controller that can transmit signals via cables to a plurality of servers may provide for transmission of state transition signals, for example, responsive to demand for server resources (e.g., in a server facility).

As an example, if a server is powered down and no Ethernet cable is plugged-in to a management port of the server (e.g., a network interface), a BMC of the server will power down and not power up until an Ethernet cable is plugged-in to the management port or, for example, the server is powered back on (e.g., a power reset, etc.).

As an example, if a server is powered down and there is an Ethernet cable plugged-in to a management port of the server (e.g., a network interface), the BMC may power down until a wake on LAN signal (e.g., energy signal, packet, etc.) is detected on the management port or, for example, the server is powered back on (e.g., a power reset, etc.).

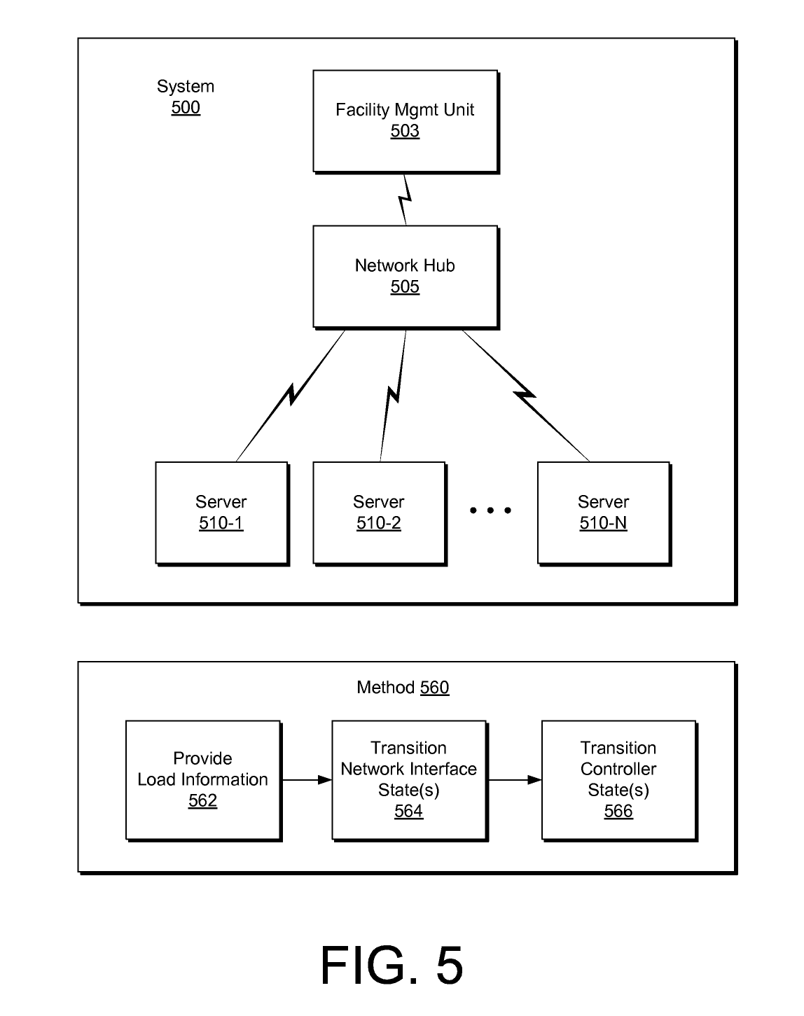

FIG. 5 shows an example of a system 500 and an example of a method 560. As shown, the system 500 can include a facility management unit 503, a network hub 505 and servers 510-1, 510-2, . . . , 510-N. As shown, the method 560 can include a provision block 562 for providing load information, a transition block 564 for transitioning one or more network interface states based at least in part on the load information and a transition block 566 for transitioning one or more controllers based at least in part on a transition of at least one network interface state.

As an example, the system 500 may be configured to implement the method 560, for example, to transition one or more network interface states of the servers 510-1, 510-2, . . . , 510-N based at least in part on load information. In turn, one or more of the servers 510-1, 510-2, . . . , 510-N may transition a power state of a respective controller.

As an example, where host components (e.g., a host) of a server is in a low power or no power state and where a controller of the server is powered, if load information indicates that demand is low or decreasing, a network hub may transmit a signal or not transmit a signal to thereby transition a state of a network interface of the server that, in turn, causes the controller to power down (e.g., power off).

As an example, a host may include one or more power states such as, for example, those defined as S0, S1, S2, S3, S4 and S5 where: S0 is an on state where a host is powered; S1 is a sleep state where a host consumes less power than S0 (e.g., host processor context maintained); S2 is a sleep state where a host consumes less power than S1 and where a host processor loses power and processor context and contents of processor cache are lost; S3 is a sleep state where a host consumes less power than S2 and where processor cache contents and chipset context are lost; S4 is a hibernate state where a host consumes the least power compared to sleep states and where a host may consume trickle power (e.g., where context data may be written to a drive); and S5 is an off state where a host is in a shutdown state and where the host (e.g., host components) retain no context. In such a scheme, for S4, a host may restart from context data stored to a drive; whereas, for S5, a host requires a reboot. As an example, transition circuitry may operate at least in part based on state of a host. For example, transition circuitry and associated logic may optionally operate based in part on “S” state of a host. As an example, state S5 may be considered a host off power state and states S0-S4 may be considered host on power states (e.g., as in the states S0-S4 some power is being consumed by one or more host components). As an example, referring to FIG. 3, the circuitry 395 may operate based at least in part on state information of the host 320, which may include state information using one or more states of the aforementioned S0-S5 scheme.

As mentioned, for a server (e.g., or other information handling system with a controller and a host), a controller may be powered (e.g., in an on power state) while a host is in an off power state (e.g., S5). In such an example, depending on a network state and optionally other information, the controller may be transitioned to a different state (e.g., an off power state or a lower power state) to reduce consumption of so-called vampire power. As an example, a controller may be transitioned to a power state where the controller consumes no power.

As an example, if a demand trend indicates that demand is decreasing or will remain low, a network hub may cause successive power downs for a plurality of controllers of respective servers (e.g., consider a chain of power downs that may depend on duration of the trend, etc.). As an example, where load information has an associated measure of certainty (e.g., or uncertainty), a system may account for such certainty, for example, by timing state transitions of network interfaces, by determining a number of network interfaces to transition, etc.

As an example, where load is increasing, a rate of increase may be used to determine how many or what percentage of network interfaces should receive transition signals to transition controllers to powered states. As an example, where load is decreasing, a rate of decrease may be used to determine how many or what percentage of network interfaces should receive transition signals to transition controllers to low power or powered off states.

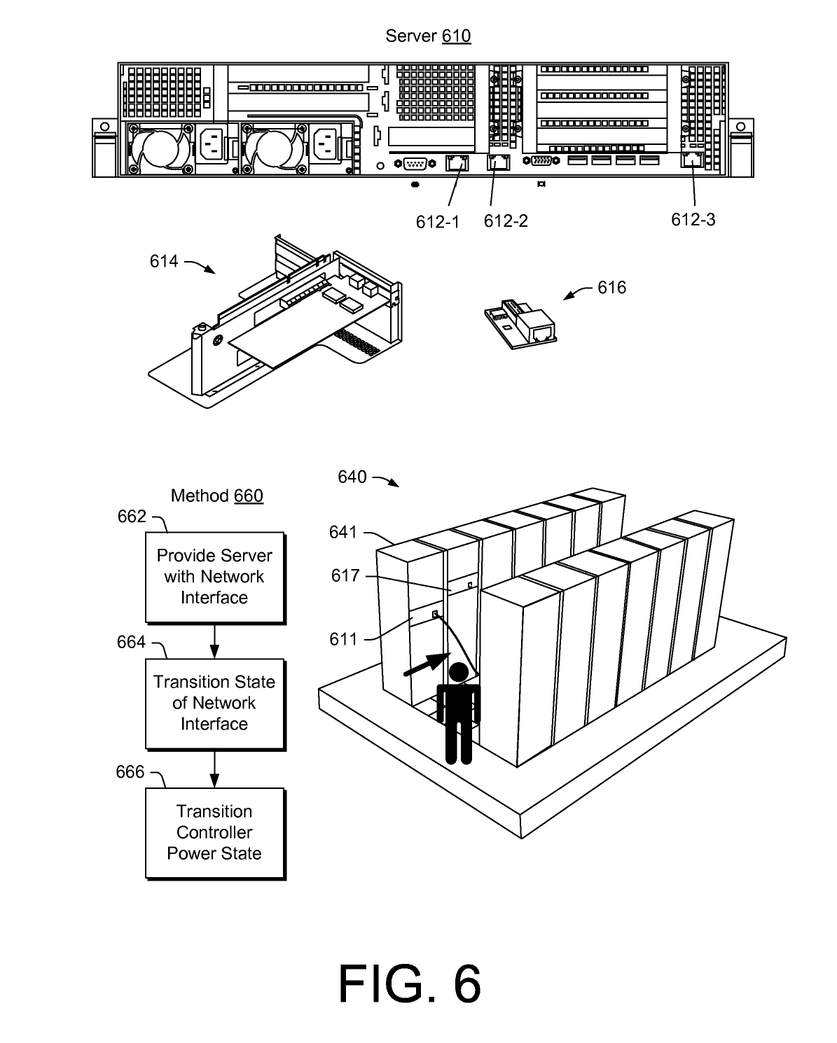

FIG. 6 shows an example of a server 610, an example of a system 640 and an example of a method 660. As shown in FIG. 6, the server 610 includes various receptacles 612-1, 612-2 and 612-3. While these are shown as back-side receptacles, one or more receptacles may be located in another location on a server. As an example, the receptacles may be associated with circuitry such as circuitry 614, circuitry 616, etc. As an example, the circuitry 614 may be a NIC, a PHY circuit, etc. As an example, the circuitry 616 may be a NIC, a PHY circuit, etc. As an example, one or more of the receptacles 612-1, 612-2 and 612-3 may include circuitry to operatively couple a plug to a controller of the server 610 (e.g., a BMC, etc.).

In the example of FIG. 6, the server 610 may include one or more detectors that can detect an electrical signal supplied to a network interface and/or a physical presence and/or absence of a plug (e.g., a cable) at a network interface. As an example, one or more of the receptacles 612-1, 612-2 and 612-3 (e.g., or other receptacle of the server 610) may be configured using one or more approaches described with respect to FIG. 4. For example, a receptacle may be defined by a receptacle housing that includes or is operatively coupled to circuitry for purposes of detecting a signal, signals, presence of a plug, absence of a plug, etc. As an example, the server 610 may include transition circuitry to transition a state of a controller responsive to a transition of a state of a network interface (e.g., and optionally based on other state information).

As an example, the system 640 may include servers such as one or more of the server 610, etc. Specifically, the system 640 is shown as including racks 641 where each rack can include servers. In the example of FIG. 6, a particular server 611 is identified, for example, to be managed by a worker, for example, the worker may unplug or plug-in a cable of one or more servers in the server installation (e.g., server facility). As shown, the server 611 includes an associated cable that may be accessible to the worker (e.g., to plug in or to unplug). As an example, the worker may unplug the cable from the server 611 to cause the server 611 to power down a controller and the worker may plug that cable into a different server 617 to cause the server 617 to power on a controller. In such an example, a single cable (e.g., an Ethernet cable) may be used as a tool to cause a state transition for one or more servers.

As to the method 660, it includes a provision block 662 for providing a server with a network interface, a transition block 664 for transitioning a state of the network interface, and a transition block 666 for transitioning a state of a controller based at least in part on the transition of the state of the network interface.

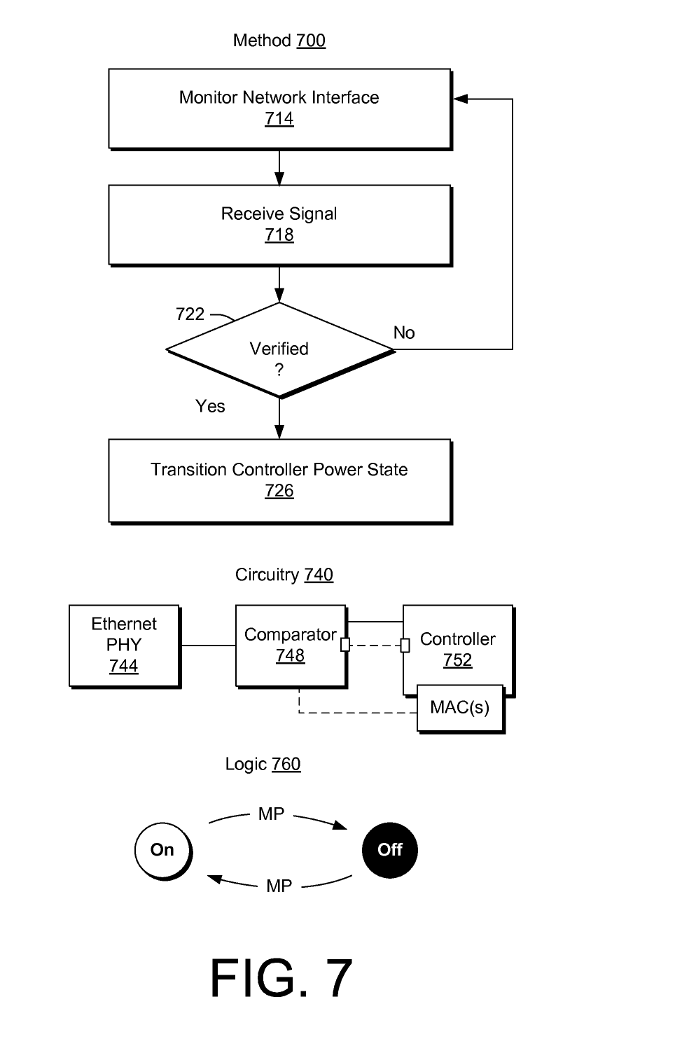

FIG. 7 shows an example of a method 700 and an example of circuitry 740. As shown, the method 700 include a monitor block 714 for monitoring a network interface, a reception block 718 for receiving a signal, a decision block 722 for verifying the signal and a transition block 726 for transitioning a controller power state if the signal is verified by the decision block 722. As indicated in the example of FIG. 7, where a received signal is not verified by the decision block 722, the method 700 may return to the monitor block 714.

In the example of FIG. 7, the circuitry 740 includes an Ethernet PHY circuit 744, a comparator circuit 748 and a controller 752 that may include one or more associated MAC addresses.

As an example, the Ethernet PHY circuit 744 may receive a signal that includes data, which may be MAC address data. In such an example, the comparator circuit 748 may compare the data to one or more MAC addresses, for example, associated with the controller 752. In such an example, where a match (e.g., favorable comparison) is found, the comparator circuit 748 may issue a signal to transition the controller 752 from a low power or power off state to a power on state (e.g., or a higher power state). As an example, such a signal may be an interrupt type of signal that directly or indirectly causes a controller to transition from one power state to another power state (see, e.g., dashed line coupling the comparator circuit 748 and the controller 752).

As an example, the comparator circuit 748 may include a switch, a by-pass, etc. to pass signals from the Ethernet PHY circuit 744 to the controller 752, for example, to one or more MAC engines (e.g., MAC modules) of the controller 752. As an example, a comparator circuit may be operatively coupled to a MII bus (e.g., for RMII, RGMII, etc.).

As an example, the controller 752 may receive and optionally transmit information via the Ethernet PHY circuit 744, directly or indirectly (e.g., via the comparator circuit 748, directly from the Ethernet PHY circuit 744, etc.).

As an example, a signal may be a magic packet. As an example, a magic packet may include a MAC address of a controller or MAC addresses of a controller. As an example, a magic packet may include a broadcast frame and a payload that may include repetitions of a MAC address.

As an example, a system may include a controller that includes one or more MAC modules, a PHY circuit and a comparator circuit. As an example, such a system may implement a wake-on-LAN method. For example, power may be provided to power the PHY circuit and the comparator circuit where a result of the comparator circuit may call for providing power to the controller.

As an example, such a system may be operationally dependent on the state of a host (e.g., one or more host components). For example, such a system may implement a wake-on-LAN method depending on a power state of a host, for example, where the host is in a low power state or a no power state.

FIG. 7 also shows an example of logic 760 that includes an on state and an off state for a controller such as, for example, the controller 752. As an example, the logic 760 may call for wake-on-LAN as well as sleep-on-LAN, for example, using circuitry such as the circuitry 740 where the comparator circuit 748 may issue a signal or signals to cause the controller 752 to either wake (e.g., transition to an on power state) or sleep (e.g., transition to an off power state). As an example, a magic packet for wake-on-LAN may be the same as a magic packet for sleep-on-LAN. As an example, a magic packet for wake-on-LAN may differ from a magic packet for sleep-on-LAN.

As an example, an apparatus can include a circuit board; a processor mounted to the circuit board; memory accessible by the processor; a storage subsystem accessible by the processor; a network interface that includes network states; a controller mounted to the circuit board and operatively coupled to the network interface where the controller includes power states; and transition circuitry that transitions the controller from one of the power states to another one of the power states responsive to a transition of the network interface from one of the network states to another one of the network states. In such an example, the network interface may be a dedicated network interface dedicated to the controller and, for example, another network interface may be provided that is operatively coupled to the processor (e.g., a host network interface). As an example, the controller may be a baseboard management controller. As an example, a circuit board may include, as separate components, a controller, PCH and a processor.

As an example, network states may include a connected state and a disconnected state. As an example, transition circuitry may transitions a controller from an on power state to an off power state responsive to a transition of a network interface from a connected state to a disconnected state. As an example, transition circuitry may transition a controller from an off power state to an on power state responsive to a transition of a network interface from a disconnected state to a connected state.

As an example, a network interface may include a cable connector (e.g., a receptacle of a receptacle housing) where a connected state and a disconnected state correspond to presence of a cable at the cable connector and absence of a cable at the cable connector, respectively.

As an example, network states may include a sleep state and a wake state that correspond to absence of a signal at the network interface and presence of a signal at the network interface, respectively.

As an example, a signal may be or include an Ethernet signal. As an example, transition circuitry may transition a controller from an off power state to an on power state responsive to a transition of a network interface from a sleep state to the wake state. As an example, a transition of a network interface from a sleep state to a wake state may occur responsive to receipt of a magic packet at the network interface.

As an example, a network state may be a listening state, for example, for a PHY circuit and optionally for a comparator circuit operatively coupled to the PHY circuit. In such an example, the listening state may be operative while a controller is in a powered on state, a powered off state or another power state (e.g., an intermediate power state, which may be a low power state).

As an example, a sleep state of a network interface may be a no power state. As an example, a sleep state of a network interface may be a listening state.

As an example, transition circuitry may transition a state of a controller from an off power state to an on power state responsive to supply of power to a circuit board (e.g., that includes host components, etc.).

As an example, a method may include providing an apparatus that includes a circuit board, a processor mounted to the circuit board, memory accessible by the processor, a storage subsystem accessible by the processor, a network interface that includes network states, a controller mounted to the circuit board and operatively coupled to the network interface where the controller includes power states, and transition circuitry that transitions the controller from one of the power states to another one of the power states responsive to a transition of the network interface from one of the network states to another one of the network states; and transitioning the controller from one of the power states to another one of the power states responsive to a transition of the network interface from one of the network states to another one of the network states.

As an example, a method may include transitioning a controller from a first power state to a second power state responsive to a transition of a network interface from a first network state to a second network state.

As an example, a method may include transitioning a controller from an off power state to an on power state responsive to transition of a network interface from a disconnected network state to a connected network state.

As an example, a method may include transitioning a controller from an on power state to an off power state responsive to transition of a network interface from a connected network state to a disconnected network state.

As an example, a method may include transitioning a controller from an off power state to an on power state responsive to transition of a network interface from a sleep network state to a wake network state. In such an example, the transition of the network interface from the sleep network state to the wake network state may include receiving a wake signal at the network interface (e.g., a signal with energy, a signal with data, a signal with a magic packet, etc.).

As an example, a server can include a motherboard; a host network interface; a processor mounted to the motherboard and operatively coupled to the host network interface; memory accessible by the processor; a storage subsystem accessible by the processor; a controller network interface that includes network states; a controller mounted to the motherboard and operatively coupled to the controller network interface where the controller includes power states; and transition circuitry that transitions the controller from one of the power states to another one of the power states responsive to a transition of the controller network interface from one of the network states to another one of the network states. As an example, a server may include a plurality of processors. As an example, a storage subsystem of a server may be or include a RAID controller and disk drives.

As an example, an apparatus may include a circuit board; a processor mounted to the circuit board; memory accessible by the processor; a storage subsystem accessible by the processor; a network interface that includes a sleep state and a wake state; a controller mounted to the circuit board and operatively coupled to the network interface where the controller includes an on state and an off state; and transition circuitry that transitions the state of the controller responsive to a transition of the state of the network interface.

As an example, a system may include a hypervisor, for example, executable to manage one or more operating systems. With respect to a hypervisor, a hypervisor may be or include features of the XEN® hypervisor (XENSOURCE, LLC, LTD, Palo Alto, Calif.). In a XEN® system, the XEN® hypervisor is typically the lowest and most privileged layer. Above this layer one or more guest operating systems can be supported, which the hypervisor schedules across the one or more physical CPUs. In XEN® terminology, the first “guest” operating system is referred to as “domain 0” (dom0). In a conventional XEN® system, the dom0 OS is booted automatically when the hypervisor boots and given special management privileges and direct access to all physical hardware by default. With respect to operating systems, a WINDOWS® OS, a LINUX® OS, an APPLE® OS, or other OS may be used by a computing platform.

As described herein, various acts, steps, etc., can be implemented as instructions stored in one or more computer-readable storage media. For example, one or more computer-readable storage media can include computer-executable (e.g., processor-executable) instructions to instruct a device. As an example, a computer-readable medium may be a computer-readable medium that is not a carrier wave.

The term “circuit” or “circuitry” is used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

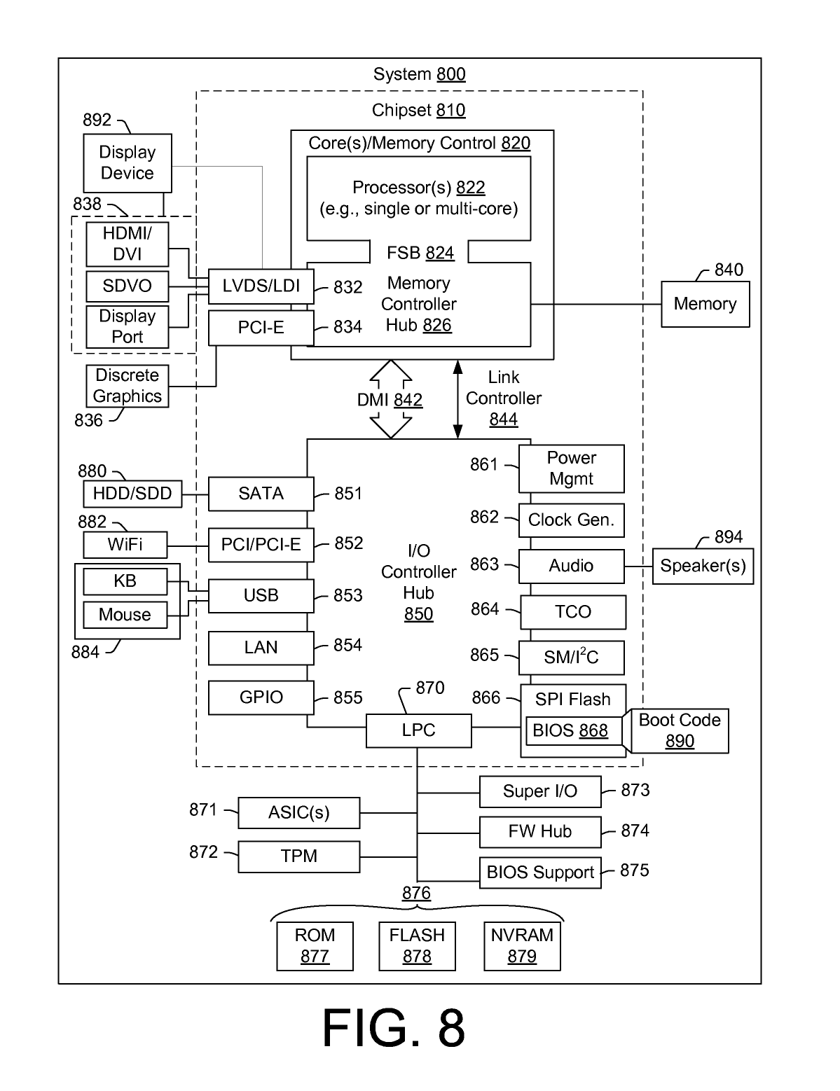

While various examples circuits or circuitry have been discussed, FIG. 8 depicts a block diagram of an illustrative computer system 800. The system 800 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a satellite, a base, a server or other machine may include other features or only some of the features of the system 800.

As shown in FIG. 8, the system 800 includes a so-called chipset 810. A chipset refers to a group of integrated circuits, or chips, that are designed to work together. Chipsets are usually marketed as a single product (e.g., consider chipsets marketed under the brands Intel®, AMD®, etc.).

In the example of FIG. 8, the chipset 810 has a particular architecture, which may vary to some extent depending on brand or manufacturer. The architecture of the chipset 810 includes a core and memory control group 820 and an I/O controller hub 850 that exchange information (e.g., data, signals, commands, etc.) via, for example, a direct management interface or direct media interface (DMI) 842 or a link controller 844. In the example of FIG. 8, the DMI 842 is a chip-to-chip interface (sometimes referred to as being a link between a “northbridge” and a “southbridge”).

The core and memory control group 820 include one or more processors 822 (e.g., single core or multi-core) and a memory controller hub 826 that exchange information via a front side bus (FSB) 824. As described herein, various components of the core and memory control group 820 may be integrated onto a single processor die, for example, to make a chip that supplants the conventional “northbridge” style architecture.

The memory controller hub 826 interfaces with memory 840. For example, the memory controller hub 826 may provide support for DDR SDRAM memory (e.g., DDR, DDR2, DDR3, etc.). In general, the memory 840 is a type of random-access memory (RAM). It is often referred to as “system memory”.

The memory controller hub 826 further includes a low-voltage differential signaling interface (LVDS) 832. The LVDS 832 may be a so-called LVDS Display Interface (LDI) for support of a display device 892 (e.g., a CRT, a flat panel, a projector, etc.). A block 838 includes some examples of technologies that may be supported via the LVDS interface 832 (e.g., serial digital video, HDMI/DVI, display port). The memory controller hub 826 also includes one or more PCI-express interfaces (PCI-E) 834, for example, for support of discrete graphics 836. Discrete graphics using a PCI-E interface has become an alternative approach to an accelerated graphics port (AGP). For example, the memory controller hub 826 may include a 16-lane (x16) PCI-E port for an external PCI-E-based graphics card. A system may include AGP or PCI-E for support of graphics.

The I/O hub controller 850 includes a variety of interfaces. The example of FIG. 8 includes a SATA interface 851, one or more PCI-E interfaces 852 (optionally one or more legacy PCI interfaces), one or more USB interfaces 853, a LAN interface 854 (more generally a network interface), a general purpose I/O interface (GPIO) 855, a low-pin count (LPC) interface 870, a power management interface 861, a clock generator interface 862, an audio interface 863 (e.g., for speakers 894), a total cost of operation (TCO) interface 864, a system management bus interface (e.g., a multi-master serial computer bus interface) 865, and a serial peripheral flash memory/controller interface (SPI Flash) 866, which, in the example of FIG. 8, includes BIOS 868 and boot code 890. With respect to network connections, the I/O hub controller 850 may include integrated gigabit Ethernet controller lines multiplexed with a PCI-E interface port. Other network features may operate independent of a PCI-E interface.

The interfaces of the I/O hub controller 850 provide for communication with various devices, networks, etc. For example, the SATA interface 851 provides for reading, writing or reading and writing information on one or more drives 880 such as HDDs, SDDs or a combination thereof. The I/O hub controller 850 may also include an advanced host controller interface (AHCI) to support one or more drives 880. The PCI-E interface 852 allows for wireless connections 882 to devices, networks, etc. The USB interface 853 provides for input devices 884 such as keyboards (KB), mice and various other devices (e.g., cameras, phones, storage, media players, etc.).

In the example of FIG. 8, the LPC interface 870 provides for use of one or more ASICs 871, a trusted platform module (TPM) 872, a super I/O 873, a firmware hub 874, BIOS support 875 as well as various types of memory 876 such as ROM 877, Flash 878, and non-volatile RAM (NVRAM) 879. With respect to the TPM 872, this module may be in the form of a chip that can be used to authenticate software and hardware devices. For example, a TPM may be capable of performing platform authentication and may be used to verify that a system or component seeking access is the expected system or component.

The system 800, upon power on, may be configured to execute boot code 890 for the BIOS 868, as stored within the SPI Flash 866, and thereafter processes data under the control of one or more operating systems and application software (e.g., stored in system memory 840).

As an example, the system 800 may include circuitry for communication via a cellular network, a satellite network or other network. As an example, the system 800 may include battery management circuitry, for example, smart battery circuitry suitable for managing one or more lithium-ion batteries.

Although various examples of methods, devices, systems, etc., have been described in language specific to structural features and/or methodological acts, it is to be understood that the subject matter defined in the appended claims is not necessarily limited to the specific features or acts described. Rather, the specific features and acts are disclosed as examples of forms of implementing the claimed methods, devices, systems, etc.

What is claimed is:

1. An apparatus comprising:
a circuit board;
a processor mounted to the circuit board;
memory accessible by the processor;
a storage subsystem accessible by the processor;
a network interface that comprises network states;
a controller mounted to the circuit board and operatively coupled to the network interface wherein the controller comprises power states; and
transition circuitry that transitions the controller from one of the power states to another one of the power states responsive to a transition of the network interface from one of the network states to another one of the network states.

2. The apparatus of claim 1 wherein the network states comprise a connected state and a disconnected state.

3. The apparatus of claim 2 wherein the transition circuitry transitions the controller from an on power state to an off power state responsive to a transition of the network interface from the connected state to the disconnected state.

4. The apparatus of claim 2 wherein the transition circuitry transitions the controller from an off power state to an on power state responsive to a transition of the network interface from the disconnected state to the connected state.

5. The apparatus of claim 2 wherein the network interface comprises a cable connector and wherein the connected state and the disconnected state correspond to presence of a cable at the cable connector and absence of a cable at the cable connector, respectively.

6. The apparatus of claim 1 wherein the network states comprises a sleep state and a wake state that correspond to absence of a signal at the network interface and presence of a signal at the network interface, respectively.

7. The apparatus of claim 6 wherein the transition circuitry transitions the controller from an off power state to an on power state responsive to a transition of the network interface from the sleep state to the wake state.

8. The apparatus of claim 7 wherein the transition of the network interface from the sleep state to the wake state occurs responsive to receipt of a magic packet at the network interface.

9. The apparatus of claim 6 wherein the sleep state of the network interface is a no power state.

10. The apparatus of claim 6 wherein the sleep state of the network interface comprises a listening state.

11. The apparatus of claim 1 wherein the network interface is a dedicated network interface dedicated to the controller.

12. The apparatus of claim 1 wherein the transition circuitry transitions the state of the controller from an off power state to an on power state responsive to supply of power to the circuit board.

13. A method comprising transitioning a controller from a first power state to a second power state responsive to a transition of a network interface from a first network state to a second network state.

14. The method of claim 13 wherein the transitioning of the controller comprises transitioning the controller from an off power state to an on power state responsive to transition of the network interface from a disconnected network state to a connected network state.

15. The method of claim 13 wherein the transitioning of the controller comprises transitioning the controller from an on power state to an off power state responsive to transition of the network interface from a connected network state to a disconnected network state.

16. The method of claim 13 wherein the transitioning of the controller comprises transitioning the controller from an off power state to an on power state responsive to transition of the network interface from a sleep network state to a wake network state.

17. The method of claim 16 wherein the transition of the network interface from the sleep network state to the wake network state comprises receiving a wake signal at the network interface.

18. A server comprising:
a motherboard;
a host network interface;
a processor mounted to the motherboard and operatively coupled to the host network interface;
memory accessible by the processor;
a storage subsystem accessible by the processor;
a controller network interface that comprises network states;
a controller mounted to the motherboard and operatively coupled to the controller network interface wherein the controller comprises power states; and
transition circuitry that transitions the controller from one of the power states to another one of the power states responsive to a transition of the controller network interface from one of the network states to another one of the network states.

19. The server of claim 18 comprising a plurality of processors.

20. The server of claim 18 wherein the storage subsystem comprises a RAID controller and disk drives.
